(19) United States
(12) Patent Application Publication
(10) Pub. No.: US 2003/0152102 A1
(43) Pub. Date: Aug. 14, 2003

(54) Method and apparatus for predicting a frame type

(76) Inventors: William Morgan, Marengo, IL (US); Donald P. Cordell, Woodstock, IL (US); Michael J. Kinnavy, Park Ridge, IL (US)

Correspondence Address: MOTOROLA, INC., 1303 EAST ALGONQUIN ROAD, IL01/3RD, SCHAUMBURG, IL, 60196

(21) Appl. No.: 10/364,608

(22) Filed: Feb. 11, 2003

Related U.S. Application Data
(60) Provisional application No. 60/356,320, filed on Feb. 12, 2002.

(51) Int. Cl. H04J 3/16

(52) U.S. Cl. 370/465

(57) ABSTRACT

The DTX status of the Reverse Dedicated Control Channel (DCCH), Reverse Supplemental Channels (SCHs), along with the status of the Erasure Indicator Bit (EIB) is encoded using reverse power control bits transmitted by the mobile system on the Reverse PICH. Particularly, eight reverse secondary power control subchannel bits areredefined to include DTX and EIB information for the various channels.

### FIELD OF THE INVENTION

The present invention relates generally to communication systems and in particular, to a method and apparatus for predicting a frame type in such communication systems.

### BACKGROUND OF THE INVENTION

Within a communication system, transmissions are conducted between a transmitting device and a receiving device over a communication resource, commonly referred to as a communication channel. During typical transmission, the transmitting device will not transmit 100% of the time, but instead will transmit information in a periodic fashion. For example, in a system employing a Code Division Multiple Access 2000 (CDMA 2000) protocol, when there is no data to send, a DTX frame is sent on the supplemental channel and the dedicated control channel (DCCH).

A problem exists in current communication systems in that the radio access network (RAN) confuses erased and DTX frames a significant percentage of the time. More particularly, poor-quality voice frames are often confused with DTX frames, and vice versa. Confusing erased voice frames and DTX frames results in a negative Radio Frequency (RF) impact as well as degraded voice quality. In particular, because both inner and outer power control is based on the reception of poor (erased) frames, misidentifying DTX frames as erased (and vice-versa) results in a divergence of the channel power from the intended target frame error rate (FER). Because of this, if the power-control threshold is set such that erasure frames are misidentified as DTX, the reverse outer power control loop will lower its set point excessively, leading to a degradation in link quality. Therefore, a need exists for method and apparatus for predicting a frame type in a communication system that eliminates the above-mentioned problems.

### BRIEF DESCRIPTION OF THE DRAWINGS

FIG. 1 is a block diagram of a communication system in accordance with the preferred embodiment of the present invention.

FIG. 2 illustrates over-the-air channel structures for a CDMA 2000 communication system in accordance with the preferred embodiment of the present invention.

FIG. 3 illustrates a pilot channel frame structure in accordance with the preferred embodiment of the present invention.

FIG. 4 is a block diagram of the remote unit of FIG. 1 in accordance with the preferred embodiment of the present invention.

FIG. 5 is a more-detailed illustration of the pilot channel frame structure of FIG. 3 in accordance with the preferred embodiment of the present invention.

FIG. 6 is a flow chart showing operation of the remote unit of FIG. 1 in accordance with the preferred embodiment of the present invention.

FIG. 7 is a block diagram of the base station of FIG. 1 in accordance with the preferred embodiment of the present invention.

FIG. 8 is a flow chart showing operation of the base station of FIG. 1 in accordance with the preferred embodiment of the present invention.

### DETAILED DESCRIPTION OF THE DRAWINGS

To address the above-mentioned need, a method and apparatus for predicting a frame type is provided herein. In accordance with the preferred embodiment of the present invention, the DTX status of the Reverse DCCH, Reverse SCHs, along with the status of the Erasure Indicator Bit is encoded using reverse power control bits transmitted by the mobile system on the Reverse PICH. Particularly, eight reverse secondary power control subchannel bits areredefined to include DTX and EIB information for the various channels.

By transmitting frame types as described above, the probability that the RAN will confuse erased voice frames and DTX frames is reduced. Because of this, RF impact is improved and situations resulting in an artificially high power control set point that results from DTX frames being misclassified as erasures are eliminated.

The present invention encompasses a method comprising the steps of determining a first channel's frame type, determining a second channel's frame type, and generating a vector representative of the first and the second channels' frame type. The vector is transmitted over a third channel.

The present invention additionally encompasses a method comprising the steps of receiving a frame over a first channel and stripping bits from the frame to generate a vector. A frame type of a second and third channel is determined based on the vector.

The present invention additionally encompasses an apparatus comprising first channel circuitry, second channel circuitry, and third channel circuitry. The apparatus additionally encompasses logic circuitry determining frame types utilized by the first and the second channel circuitry, generating a vector representative of the frame types, and transmitting the vector via the third channel circuitry.

The present invention additionally encompasses an apparatus comprising receiving circuitry for receiving a first, second, and third channel and stripping circuitry for stripping bits of the third channel. The apparatus additionally encompasses circuitry for determining a first and a second channel type based on the stripped bits.

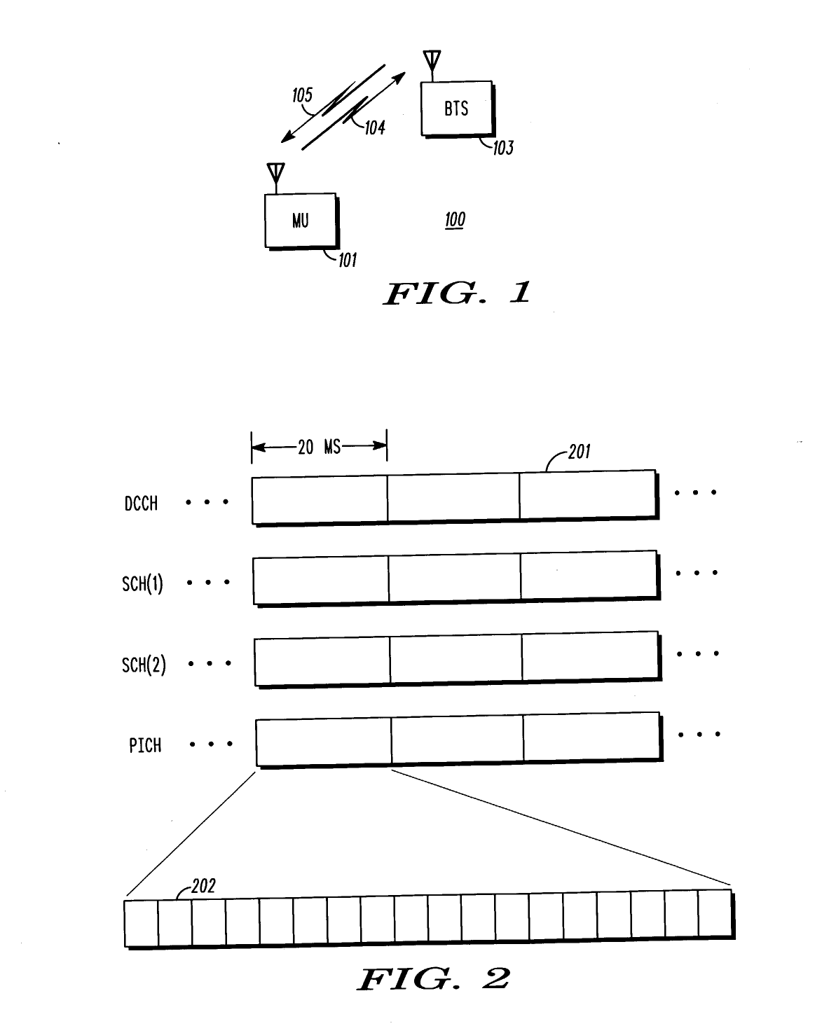

Turning now to the drawings, wherein like numerals designate like components, FIG. 1 is a block diagram of communication system 100 in accordance with the preferred embodiment of the present invention. In the preferred embodiment of the present invention, communication system 100 utilizes a Code Division Multiple Access (CDMA) system protocol as described in Cellular System Remote unit-Base Station Compatibility Standard of the Electronic Industry Association/Telecommunications Industry Association Interim Standard 2000 (CDMA 2000). (EIA/TIA can be contacted at 2001 Pennsylvania Ave. NW Wash. D.C. 20006). In alternate embodiments communication system 100 may utilize other cellular communication system protocols such as but not limited to the Global System for Mobile Communications (GSM) protocol, IS-136, IS-95, or IS-833.

As shown remote, or mobile unit (MU) 101 is communicating with base transceiver station (BTS) 103 via uplink communication signal 104, while BTS 103 is communicating with mobile unit 101 via downlink communication signal 105. As one of ordinary skill in the art will recognize, several channels are utilized for both uplink and downlink communication between remote unit 101 and base station 103. In particular, typical voice communication in a CDMA 2000 system takes place utilizing a common traffic channel (fundamental channel (FCH)). Additionally, remote unit data transmission within a CDMA 2000 communication system takes place by assigning the remote unit multiple high-speed data channels (referred to as a supplemental channels (SCHs)) and transmitting data over the supplemental channels. A dedicated control channel (DCCH) is utilized to transmit control information such as signaling information between remote unit 101 and base station 103. Finally, both an uplink and a downlink pilot channel (PICH) are utilized in a CDMA 2000 system to provide coherent demodulation and power control.

As discussed above, a problem arises in that prior-art base stations will confuse erased frames and DTX frames a significant percentage of the time. In order to solve this problem, in the preferred embodiment of the present invention the DTX status of the Reverse DCCH, Reverse SCHs, along with the status of the Erasure Indicator Bit is encoded using reverse power control bits transmitted by the mobile system on the Reverse PICH. Particularly, eight reverse secondary power control subchannel bits areredefined to include DTX and EIB information for the various channels.

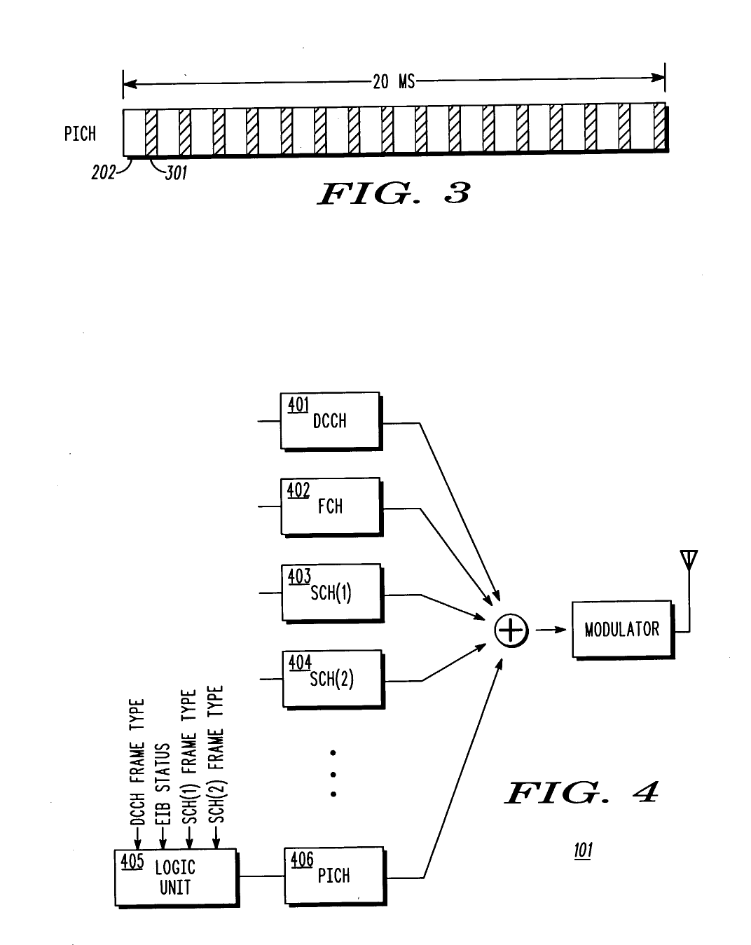

FIG. 2 illustrates over-the-air channel structures for an CDMA 2000 communication system. As described in CDMA 2000 each channel's transmission is divided into logical frames 201 that are 20 milliseconds (ms) in length. Additionally, as known in the art, each frame 201 is further divided into 16 smaller portions 202 (or slots 202) which are referred to as power control groups. As shown in FIG. 3, each power-control group 202 for the pilot channel contains a single power-control bit (PCB) 301. Although in the preferred embodiment of the present invention each power-control group ends with a single PCB 301, in alternate embodiments, the PCBs 301 may be located anywhere within the PCG 202.

In prior-art systems, the 16 power-control bits 301 are utilized for the remote unit 101 to instruct base station 103 to increase or decrease downlink transmission power. More particularly, in prior-art systems base station 103 receives a particular paging-channel frame and determines the values of the 16 power control bits. If the majority of the power-control bits are a “0”, then downlink power is increased. Conversely, if the majority of power-control bits for the frame are “1”, then downlink power is decreased.

In the preferred embodiment of the present invention, eight of the sixteen PICH power-control bits are utilized to indicate the frame type for the other channels being transmitted by the mobile unit. Therefore, in accordance with the preferred embodiment of the present invention, eight bits are still utilized by base station 103 for power control, however, unlike prior-art systems, eight bits from the Pilot Channel are utilized by base station 103 to indicate frame types for the differing channels.

The four necessary indicators are mapped to 16 unique code vectors out of a 256 code vector space. The code vectors are implemented using an 4×8 extended hamming code. The 16 codes maximize the hamming distance and allows correction of one error bit. The hamming distance of each code is at least 4 bits. The base station receives the encoded bits on the R-PICH and applies a maximum likelihood decoder to the received data. In this manner, the mobile notifies the base station of each DTX frame that it transmits. This method raises the probability of successful DTX detection to 96%. The preferred embodiment of the present invention allows the correct frame information to be sent to the Reverse Outer Power Control Loop so that the R-SCH and R-DCCH converge to their correct FER targets.

FIG. 4 is a block diagram of remote unit 101 of FIG. 1 in accordance with the preferred embodiment of the present invention. As shown, remote unit 101 comprises Dedicated Control Channel circuitry 401, Fundamental Channel circuitry 402, first Supplemental Channel circuitry 403, second Supplemental Channel circuitry 404, and Pilot Channel circuitry 406. The outputs from these channels are summed, modulated, and transmitted as described in CDMA 2000.

As described above, a problem arises in that prior-art base stations will confuse erased frames and DTX frames a significant percentage of the time. In order to solve this problem, in the preferred embodiment of the present invention frame type for a plurality of channels are input into logic unit 405, and logic unit 405 modifies a transmission pattern of a channel based on the frame types. More particularly, DCCH frame type, EIB status, SCH(0) frame type, and SCH(1) frame type are input into logic unit 405. In response, logic unit 405 modifies a single bit in eight of the sixteen power control groups on the PICH to inform base station 103 of each frame and EIB status.

There exists 16 possible combinations of DCCH frame type, EIB status, SCH(0) frame type, and SCH(1) frame type. The 16 possible combinations can be represented as a matrix, where a “1” indicates a DTX frame and a “0” indicates a non-DTX frame for the DCCH, SCH(0), and SCH(1), while an EIB of “1” indicates an erased downlink frame was received by the remote unit. The first column of the following matrix represents DCCH frame type, while the remaining columns represent SCH(0) frame type, SCH(1) frame type, and EIB:

$$[ \begin{matrix}0000 \\ 0001 \\ 0010 \\ 0011 \\ 0100 \\ 0101 \\ 0110 \\ 0111 \\ 1000 \\ 1001 \\ 1010 \\ 1011 \\ 1100 \\ 1101 \\ 1110 \\ 1111\end{matrix} ] . \qquad ( 1 )$$

As discussed above, in the preferred embodiment of the present invention the four indicators are mapped to 16 unique code vectors out of a 256 code vector space. The code vectors are implemented using the 4×8 extended hamming code

$$\begin{matrix}[ \begin{matrix}11101000 \\ 01110100 \\ 11010010 \\ 11111111\end{matrix} ] , such that & ( 2 ) \\ [ \begin{matrix}0000 \\ 0001 \\ 0010 \\ 0011 \\ 0100 \\ 0101 \\ 0110 \\ 0111 \\ 1000 \\ 1001 \\ 1010 \\ 1011 \\ 1100 \\ 1101 \\ 1110 \\ 1111\end{matrix} ] \times [ \begin{matrix}11101000 \\ 01110100 \\ 11010010 \\ 11111111\end{matrix} ] = [ \begin{matrix}\begin{matrix}00000000 \\ 11111111 \\ 11010010 \\ 00101101 \\ 01110100 \\ 10001011 \\ 10100110 \\ 01011001 \\ 11100000 \\ 00010111 \\ 00111010 \\ 11000101 \\ 10011100 \\ 01100011 \\ 01001110\end{matrix} \\ 10110001\end{matrix} ] . & ( 3 )\end{matrix}$$

The 16 codes maximize the hamming distance and to allow correction of one error bit. The hamming distance of each code is at least 4 bits. The Hamming distance between each possible combination

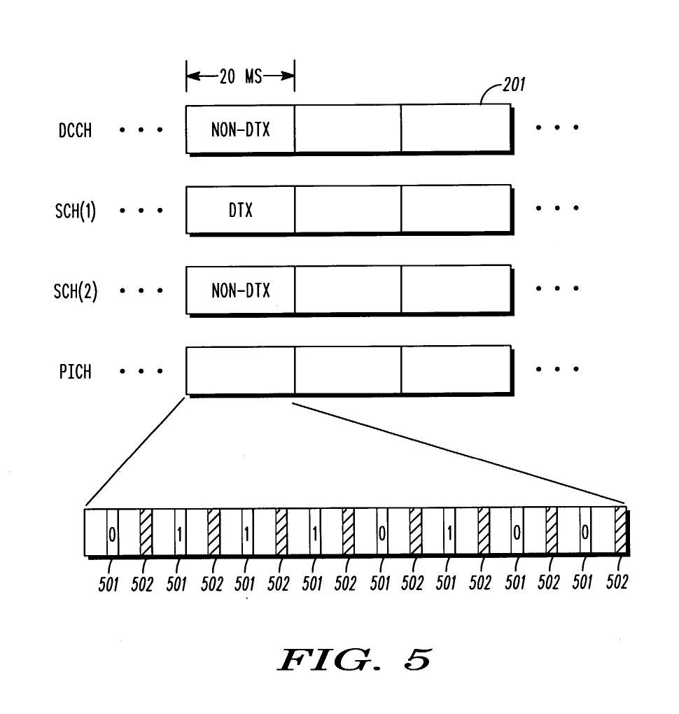

FIG. 5 is a more-detailed illustration of the pilot channel frame structure in accordance with the preferred embodiment of the present invention. As shown, the DCCH and SCH(1) channels are transmitting non-DTX frames, while the SCH(0) channel is transmitting a DTX frame. Although not shown, for illustration purposes, it is assumed that the EIB is set to “0”. Based on this information, the fifth row from matrix (1) represents the transmission pattern. More particularly, using the first column of matrix (1) as DCCH frame type, and the remaining columns as SCH(0) frame type, SCH(1) frame type, and EIB, respectively, the resulting vector for the above set of frames and EIB can be written as [0100].

As discussed above, the four necessary indicators [0100] is mapped to an eight-dimensional vector via multiplication with matrix (2). Thus, the actual vector transmitted would be the fifth row of matrix (3), or [01110100 ]. In the preferred embodiment of the present invention the vector is transmitted as shown in FIG. 5 in the odd power-control bit positions 501, however one of ordinary skill in the art will recognize that the eight-bit vector may be transmitted in any eight of the sixteen power-control bit positions. Additionally, the remaining eight power-control bit positions 502 are utilized for power-control as described in CDMA 2000.

FIG. 6 is a flow chart showing operation of the remote unit of FIG. 1 in accordance with the preferred embodiment of the present invention. The logic flow begins at step 601 where logic unit 405 determines a first, second, and a third channel frame type. As discussed above, in the preferred embodiment of the present invention the first, second, and third channel type comprises a DCCH, SCH(0), and SCH(1) frame type. At step 603 logic unit 405 determines an EIB bit type. As discussed above, the EIB bit identifies whether a downlink frame received by the remote unit was received as an erasure.

Continuing, at step 605 a 4-bit vector is generated. In particular, a 4-bit vector is generated where a “1” indicates a DTX frame and a “0” indicates a non-DTX frame for the DCCH, SCH(0), and SCH(1), while an EIB of “1” indicates an erased downlink frame was received by the remote unit. An 8-bit vector is generated from the 4-bit vector via matrix multiplication (step 607) and the 8-bit vector is transmitted on a fourth channel (step 609). In particular, in the preferred embodiment of the present invention, the 8-bit vector is transmitted over the PICH with one bit being transmitted in each of eight power control groups.

By transmitting frame types as described above, the probability that the RAN will confuse erased voice frames and DTX frames is reduced. Because of this, RF impact is improved and situations resulting in an artificially high power control set point that results from DTX frames being misclassified as erasures are eliminated.

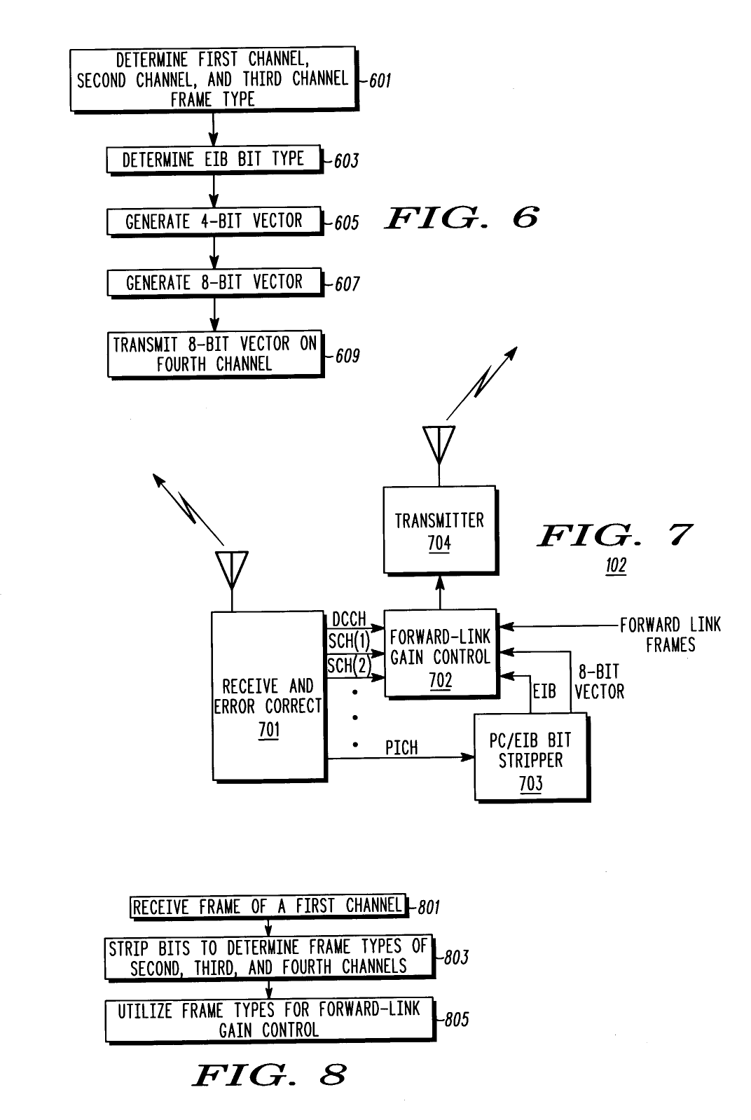

FIG. 7 is a block diagram of base station 103 of FIG. 1 in accordance with the preferred embodiment of the present invention. As shown, base station 103 comprises receiver and error corrector 701, PC/EIB bit stripper 703, Forward-link gain controller 702, and transmitter 704. Operation of base station 103 in accordance with the preferred embodiment of the present invention occurs as follows: receiver 701 receives over-the-air transmissions from remote unit 101 and outputs individual DCCH, SCH(0), SCH(1), and PICH channels. The DCCH, SCH(0), SCI(1) channels are sent inter alia, to gain control circuitry 702. As discussed above, both inner and outer power control is based on the reception of poor (erased) frames and the EIB. That is, when gain-control circuitry 702 detects a poor frame or an EIB, the gain is increased (as described in CDMA 2000) for all forward link frames. Therefore, in accordance with the preferred embodiment of the present invention EIB bits, and DCCH, SCH(0), and SCH(1) channels are input into gain controller 702.

As described above, a problem exists in prior-art communication systems in that base station 103 confuses erased and DTX frames a significant percentage of the time. In order to solve this problem, an 8-bit vector identifying DCCH, SCH(0), and SCH(1) frame types is input into forward link gain control circuitry 702. From this vector, circuitry 702 can identify which frames where transmitted as DTX frames, and which frames were not. More particularly, circuitry 702 maps the 8-bit vector to one of 16 possible transmission patterns, such that for any received row of matrix (3) corresponds to a transmission scheme for the corresponding row of matrix (1). That is,

$$\begin{matrix}Received vector & & Transmission Pattern \\ [ \begin{matrix}\begin{matrix}00000000 \\ 11111111 \\ 11010010 \\ 00101101 \\ 01110100 \\ 10001011 \\ 10100110 \\ 01011001 \\ 11100000 \\ 00010111 \\ 00111010 \\ 11000101 \\ 10011100 \\ 01100011 \\ 01001110\end{matrix} \\ 10110001\end{matrix} ] & -> & [ \begin{matrix}0000 \\ 0001 \\ 0010 \\ 0011 \\ 0100 \\ 0101 \\ 0110 \\ 0111 \\ 1000 \\ 1001 \\ 1010 \\ 1011 \\ 1100 \\ 1101 \\ 1110 \\ 1111\end{matrix} ] .\end{matrix}$$

In this manner, the mobile notifies the base station of each DTX frame that it transmits. This method raises the probability of successful DTX detection to 96%. It will allow the correct frame information to be sent to the Reverse Outer Power Control Loop so that the R-SCH and R-DCCH converge to their correct FER targets.

FIG. 8 is a flow chart showing operation of base station 103 of FIG. 1 in accordance with the preferred embodiment of the present invention. The logic flow begins at step 801 where a frame from a first channel is received by bit stripper 703. In particular, at step 801 a frame for a PICH is received by bit stripper 703. At step 803 a single bit is stripped from each power control group in order to determine frame types of a second, third, and fourth channel. In particular at step 803, a single bit is stripped from each power control group in the PICH frame to determine the DCCH, SCH(0), and SCH(1) frame type. The frame types are output to forward-link gain control circuitry 702 and are utilized to power control forward link frames (step 805). The forward link frames are eventually transmitted via transmitter 704.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method comprising the steps of:
determining a first channel's frame type;
determining a second channel's frame type;
generating a vector representative of the first and the second channels' frame type; and
transmitting the vector over a third channel.

2. The method of claim 1 wherein the step of determining the first channel's frame type comprises the step of determining if the first channel's frame type is a DTX or non-DTX frame type.

3. The method of claim 2 wherein the step of determining the first channel's frame type comprises the step of determining a supplemental channel frame type.

4. The method of claim 3 wherein the step of determining the second channel's frame type comprises the step of determining a dedicated control channel's frame type.

5. The method of claim 1 further comprising the steps of:
determining an erasure indicator bit; and
wherein the step of generating the vector comprises the step of generating the vector representative of the first and the second channel frame type and additionally representative of the erasure indicator bit.

6. The method of claim 1 wherein the step of generating the vector comprises the step of generating the vector utilizing an extended Hamming code.

7. The method of claim 1 wherein the step of transmitting the vector over the third channel comprises the step of transmitting the vector over the third channel, wherein each bit of the vector is transmitted in a separate power-control group within a single frame.

8. The method of claim 1 wherein the step of transmitting the vector over the third channel comprises the step of transmitting the vector over a pilot channel.

9. A method comprising the steps of:
receiving a frame over a first channel;
stripping bits from the frame to generate a vector;
determining a frame type of a second channel based on the vector; and
determining a frame type of a third channel based on the vector.

10. The method of claim 9 further comprising the step of power controlling a fourth channel based on the vector.

11. The method of claim 9 wherein the step of determining a frame type of the second channel comprises the step of determining if the second channel's frame type is a DTX or non-DTX frame type.

12. The method of claim 9 wherein the step of receiving the frame over the first channel comprises the step of receiving the frame over a pilot channel.

13. The method of claim 9 wherein the step of determining the frame type of the second channel comprises the step of determining the frame type of a dedicated control channel.

14. The method of claim 9 wherein the step of determining the frame type of the third channel comprises the step of determining the frame type of a supplemental channel.

15. An apparatus comprising;
first channel circuitry;
second channel circuitry;
third channel circuitry; and
logic circuitry determining frame types utilized by the first and the second channel circuitry, generating a vector representative of the frame types, and transmitting the vector via the third channel circuitry.

16. The method of claim 15 wherein the first channel circuitry comprises supplemental channel circuitry.

17. The method of claim 16 wherein the second channel circuitry comprises dedicated control channel circuitry.

18. The method of claim 17 wherein the third channel circuitry comprises pilot channel circuitry.

19. An apparatus comprising:
receiving circuitry for receiving a first, second, and third channel;
stripping circuitry for stripping bits of the third channel; and
circuitry for determining a first and a second channel type based on the stripped bits.

20. The apparatus of claim 19 wherein the first, second, and third channels comprise a dedicated control channel, a supplemental channel, and a pilot channel, respectively.
